(19) United States
(12) Patent Application Publication
(10) Pub. No.: US 2011/0241237 A1
(43) Pub. Date: Oct. 6, 2011

(54) REPAIR OF HEATING WALLS IN A REFRACTORY FURNACE

(76) Inventors: Dan Drakulich, Brook Park, OH (US); Jerry Scott, Brook Park, OH (US); David Ison, Ashland, KY (US); Martin Dusel, Indianapolis, IN (US)

(21) Appl. No.: 12/740,888

(22) PCT Filed: Oct. 29, 2008
(86) PCT No.: PCT/GB2008/003686

§ 371 Date: Apr. 19, 2011

Related U.S. Application Data
(60) Provisional application No. 60/996,104, filed on Nov. 1, 2007.

(30) Foreign Application Priority Data
Jan. 18, 2008 (IN) 151/DEL/2008

(51) Int. Cl. F27D 1/16

(52) U.S. Cl. 264/30

(57) ABSTRACT

A method of repairing a refractory brick wall in a furnace that includes: (a) identifying a refractory brick wall or portion thereof that requires repair/reconstruction, pre engineering construction dimensions and accommodating various battery oven designs and oven heating systems; (b) demolishing the refractory brick wall or wall portion thereof identified in step (a); (c) installing outer reusable forms in situ, defining a new wall or portion thereof; (d) installing inner consumable forms defining one or more passageways within the new wall or portion thereof; and (e) pouring castable material into one or more areas bounded by the outer forms; (f) curing said castable material; and (g) removing the outer reuseable forms.

This invention relates generally to repair of Silica brick heating walls in a refractory furnace, and more specifically, in a non-limiting and exemplary embodiment, to the repair of Silica brick heating walls, roof and/or corbel areas in a coke oven.

### BACKGROUND OF THE INVENTION

Typically, coke is produced in a coke oven battery which includes a plurality of side-by-side coking chambers or ovens which are separated from each other by heating walls, the heating walls extending the full length of the chambers. The ovens are sometimes' referred to as “pushing ovens” because after the coking process, the coke is pushed in the lengthwise direction out of the ovens. A typical coke oven installation might include, for example 30 to more than 100 individual coking chambers or ovens in side-by-side relationship, with each chamber being from 3 to 7 meters high, typically 14 or more meters long, and approximately ½-1 meter wide. Each heating wall is typically built up from a number of horizontally extending courses of silica bricks, the bricks being assembled to define vertically and/or horizontally extending internal flues or vents (and other passages) within the heating walls.

In time, due primarily to the harsh thermal cycling environment, coking coal pressures or operating practices on some or all of the heating walls, roof and/or corbel areas require repair and/or reconstruction.

Currently, heating walls in coke ovens are typically repaired by replacing individual bricks in the damaged area(s). See, for example, U.S. Pat. No. 2,476,305. A more recent patent, U.S. Pat. No. 4,452,749, discloses molding individual replacement bricks from a castable refractory material. These processes, however, are very labor intensive, costly and time consuming.

There remains a need for a simpler and less costly repair process, particularly in those instances where the expected remaining useful life of the installation is between 5-20 years.

### BRIEF DESCRIPTION OF THE INVENTION

In accordance with a non-limiting exemplary embodiment, there is disclosed herein a new process for the repair or replacement (reconstruction) of damaged heating walls (and/or roof and corbel areas) in a coke oven. Specifically, that portion of a heating wall that requires repair/replacement is removed via suitable demolition procedures, with all necessary precautions taken for the safety of the workers involved. For purposes of this invention, it will be assumed that a portion of one heating wall needs reconstruction, but it will be appreciated that the repair/reconstruction process described herein is applicable to situations where entire walls, the roof (or portions thereof) and/or corbel areas need replacement. Accordingly, reference to a “refractory brick wall” is intended to encompass vertical walls as well as horizontal roof and floor (corbel) areas.

After the individual Silica bricks in the wall portion to be repaired are removed, and with suitable bracing installed as necessary, pre-engineered pre-fabricated forms are built and castable refractory material poured into the forms to form new wall sections. In the preferred arrangement, the new wall sections are built up in stages, with outer forms of about two to twelve feet in height installed along the full length of the section to be repaired. Internal, consumable forms are added to define, for example, the vertical flue vents and any other required passages. The refractory, castable material is then poured into the form and allowed to cure. Another forms stage is stacked on the first stage, and the process repeated until the new wall reaches the chamber or oven roof. Finishing procedures at the roof level will be discussed further herein.

Accordingly, in one aspect, the invention relates to a method of repairing a refractory brick wall in a furnace comprising:

(a) identifying a refractory brick wall or portion thereof that requires repair/reconstruction;

(b) demolishing the refractory brick wall or portion thereof;
(1) Establishing Benchmarks and construction dimensions for the replacement wall from engineering studies;

(c) installing outer reusable forms in situ defining a new wall or wall portion;

(d) installing inner consumable forms defining one or more passageways within the new wall or wall portion; and

(e) pumping castable material into an area bounded by the outer forms, existing Silica brick and steelwork and around the inner forms;

(f) curing the castable material; and

(g) removing said outer forms.

(h) performing a controlled heat up of new refractory

(i) Tensioning the new wall with buckstay springs

(j) developing a schedule with plant operations of returning the oven repaired back into service

In the exemplary embodiment, steps (c) through (f) are carried out to form a first section of the new wall or portion thereof of a height less than a finished height for the new wall or portion thereof; and repeating steps (c) through (e) to form one or more additional sections, stacked one on the other, until the finished height is achieved.

In another aspect, the invention relates to a method of replacing all or a portion of a Silica brick heating wall in a coke oven, the heating wall located between a pair of adjacent ovens and containing at least one flue passage, the method comprising:

(a) demolishing the wall or portion thereof;
(1) Establishing engineered benchmarks and construction dimensions for the repaired wall

(b) installing outer forms defining a new wall or portion thereof in situ, between the adjacent ovens, and inner consumable forms defining at least one new flue passage within the new wall or portion thereof;

(c) pumping a refractory castable material within the outer forms and around the inner forms and allowing the material to cure;

(d) removing the outer forms; and

(e) performing a controlled heat up

(f) tensioning the new wall with buckstay springs

(g) developing a schedule with plant operations of returning the repaired ovens back into service

The exemplary embodiment will now be described in connection with the drawings identified below.

### BRIEF DESCRIPTION OF THE DRAWINGS

FIG. 1 is a schematic side elevation of a plurality of side-by-side coking ovens, with repair bulkheads installed in the ovens on either side of a wall to be repaired;

FIG. 2 is a schematic plan view of the ovens shown in FIG. 1;

FIG. 3 is a plan view similar to FIG. 2 but with insulation blankets installed in the repair area;

FIG. 4 is a plan view similar to FIG. 3 but with supports installed adjacent an interface with the wall to be repaired;

FIG. 5 is an end elevation of the repair area within the oven, with additional, optional, length-wise bracing installed;

FIG. 6 is a partial perspective view of exemplary forms employed in the process of this invention;

FIG. 7 is a partial perspective view of part of a repaired wall section, showing outer and inner forms installed in a lower stage, with refractory castable material poured therein;

FIG. 8 is a schematic representation illustrating how a new wall section is built up and poured in stages;

FIGS. 9 and 10 are schematic representations illustrating how an internal flue passage is built up and poured in stages; and

FIGS. 11-16 are views of different specialty pre-engineered forms that may be used in the repair or replacement process.

### DETAILED DESCRIPTION OF THE INVENTION

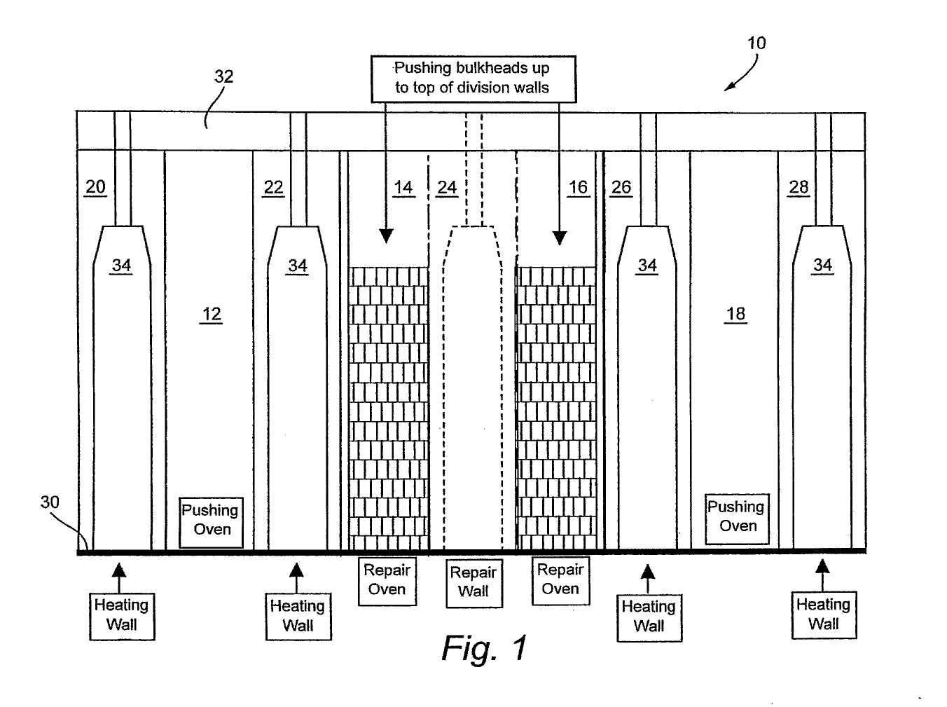

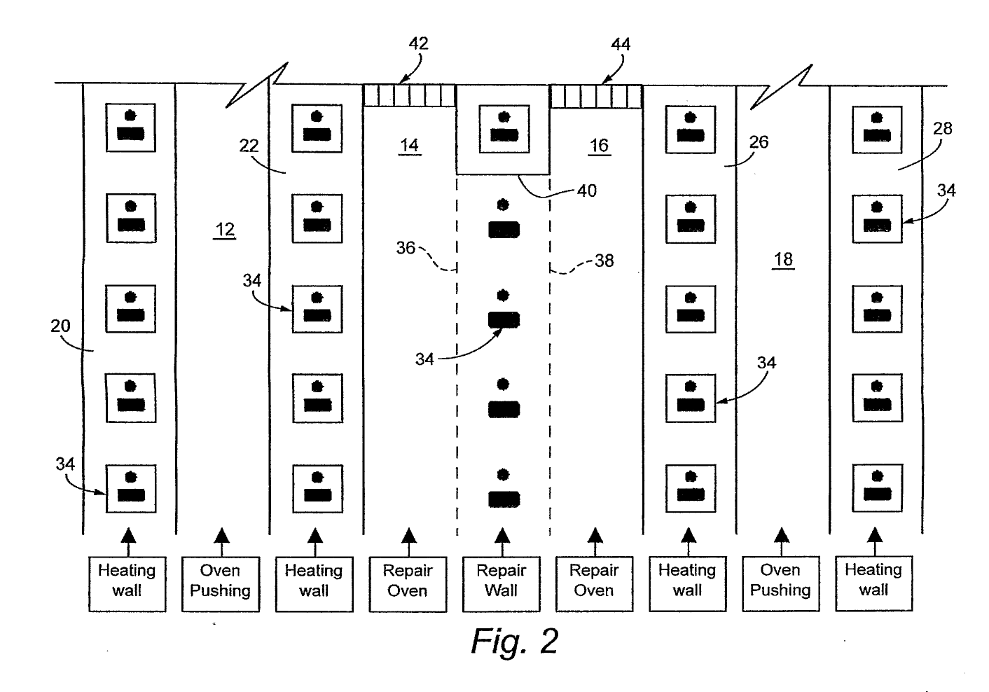

With reference initially to FIGS. 1 and 2, one section 10 of a larger coke oven is shown to include a series or plurality of substantially parallel, side-by-side heating chambers or coking ovens 12, 14, 16 and 18 separated by heating walls 20, 22, 24, 26 and 28. A floor, or corbel area is designated by numeral 30, it being understood that the floor construction is more complex than shown here. A roof 32 extends across the tops of the heating walls. It will also be understood that the Figures illustrate only a small section of the coke oven, and in a somewhat simplified manner for ease of understanding of this disclosure.

In FIGS. 1 and 2, the heating walls are each shown to include a plurality of vertically-oriented flues 34 within the interior of the walls. There may also be additional passages (e.g., horizontal flue sections, horizontal or vertical piping and the like) formed within the heating walls, all of which are encompassed by the terms “flues”, “vents” or “other passages”). Each heating wall is constructed of laid up Silica bricks, and for purposes of this disclosure, it is assumed that bricks in the heating wall 24 are damaged, thus requiring reconstruction of at least a portion of the heating wall 24 as described further below.

In the plan view of FIG. 2, it will be appreciated that the alternating heating walls and heating chambers or ovens extend in opposite directions well beyond what is shown. That portion of the heating wall 24 to be repaired is indicated by the dotted lines 36, 38, terminating at solid line 40. Thus, the portion of the wall 24 to be repaired encloses four discrete, substantially vertically-oriented flues 34, it being understood that horizontally oriented passages may also be present in the wall structure.

Initially, the areas to be reconstructed must be sealed off and, to this end, bulkheads 42, 44 are constructed within the adjacent chambers or ovens 16, 18, beyond the area to be repaired. The bulkheads 42, 44 are composed of bricks 46, e.g., 4.5×9×3 inch insulating (to 1800° F. or higher) clay bricks, laid up as best seen in FIG. 1. The bricks may be sawed to fit as necessary, and laid dry and tight against one another. The bulkheads extend substantially to the roof, effectively isolating the area to be repaired.

So-called “headache” racks (not shown) are installed prior to entering the oven chambers to provide protection from falling debris during and after demolition of the damaged wall area. These racks may comprise metal netting or similar, suspended from the roof or by other suitable means.

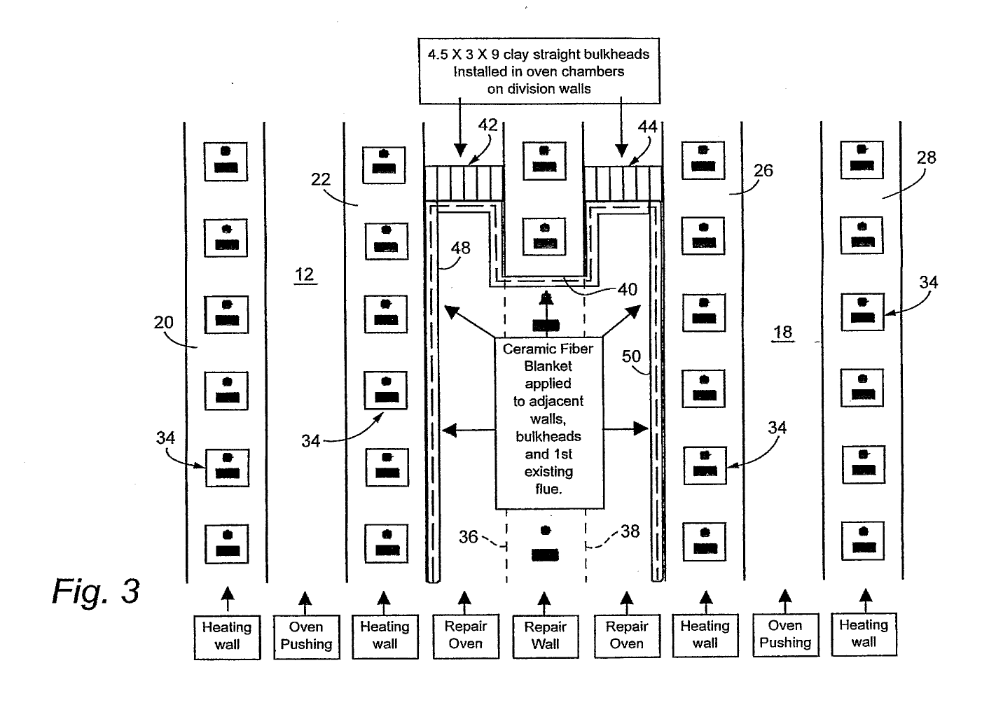

Optionally, insulation which may take the form of ceramic fibers blankets 48, 50 may be applied to the exposed walls of adjacent heating walls, and across the bulkheads 44, 46 (FIG. 3). The ceramic fiber blankets may be applied in two 1 inch or 1.5 inch layers with overlapping seams, and temporarily secured in any appropriate manner. It will be appreciated that the insulation should either be omitted along the solid wall 40, or removed therefrom in stages, as the reconstruction progresses. The insulation is particularly beneficial since the adjacent working ovens remain heated to an elevated temperature during the repair process.

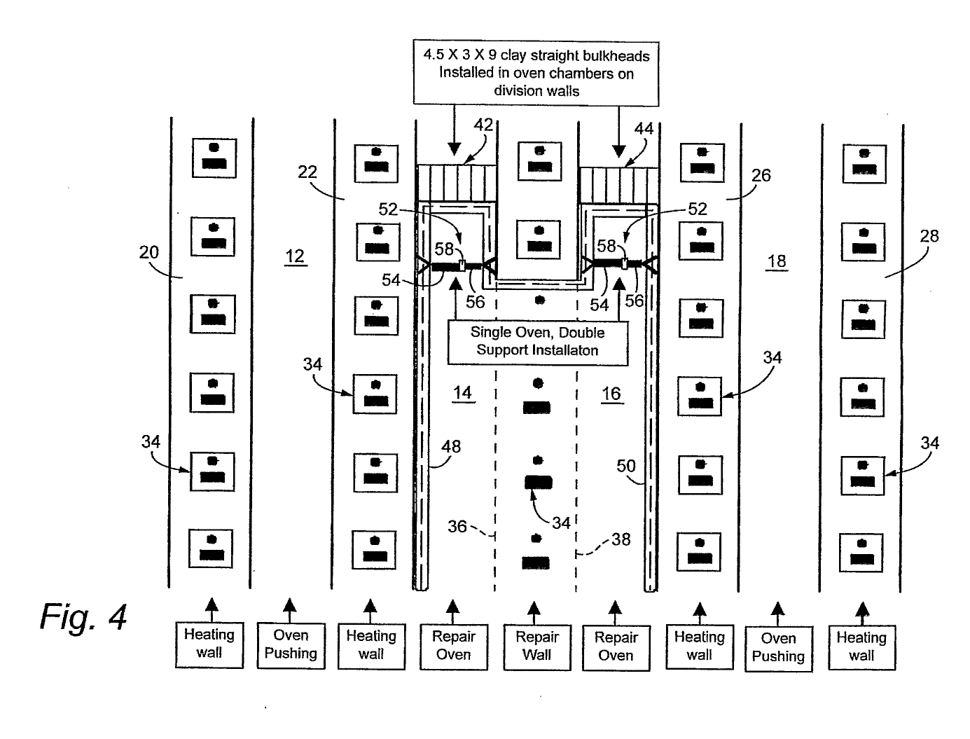

Turning to FIG. 4, after the installation of the ceramic fiber blankets, one or more braces 52 are installed between adjacent heating walls 22, 26 and that part of the wall 24 that remains, i.e., that does not require reconstruction. Each brace 52 may include a pair of threaded, telescoping rods 54, 56 and a tightening nut 58, permitting the brace to be extended into contact with adjacent wall surfaces. As many braces 52 as are needed can be vertically spaced from near the floor to near the ceiling, and similar groups of braces may be located as desired. It will be appreciated that ceiling supports may also be utilized as needed. These braces or supports will stabilize the existing walls and flues.

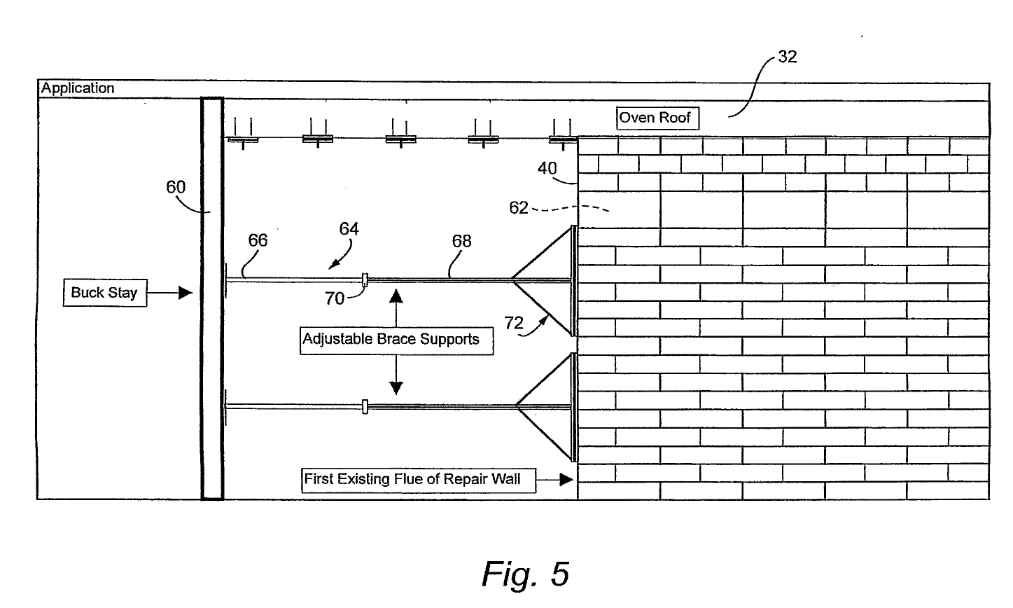

With this preliminary work completed, demolition can begin, with the damaged (and surrounding, to the extent desired) refractory bricks removed from the top down. At some point in the demolition process, it may be necessary or desirable to shore-up the existing, remaining portion of the heating wall being repaired. More specifically, a vertically oriented “buck stay” (I-Beam) 60 may optionally be installed remote from the existing flue 62 of the repair wall, as best seen in FIG. 5. One or more adjustable, horizontally-oriented brace supports 64 may extend between the brick stay 60 and existing flue wall 62, thus preventing the existing flue wall from moving out toward the opening created during demolition. The supports 64 may again may include telescoping, threaded rods 66, 68 and an expansion nut 70, with a broader support portion 72 adapted to engage the existing wall.

As demolition continues, additional bracing may be installed as needed. After all of the damaged and surrounding wall bricks have been removed, the area is cleaned and prepared for the new wall construction. These new walls are constructed using a combination of reuseable and consumable forms similar to those used in typical concrete wall constructions.

With particular reference to FIG. 6, the outer wall forms 74,76 may be constructed of plywood, aluminum, a laminate construction of wood and metal (for example, plywood on the inner side and a metal such as aluminum on the outer side), or other suitable material. The inner forms are preferably wood, fiberboard, cardboard, PVC or other suitable consumable material that will burn off when the repaired oven is heated upon completion of the reconstruction work. Preferably, the form work is constructed in stages, with forms having a height of 24-30 inches preferred, and a length equal to the applicable length of the wall to be repaired.

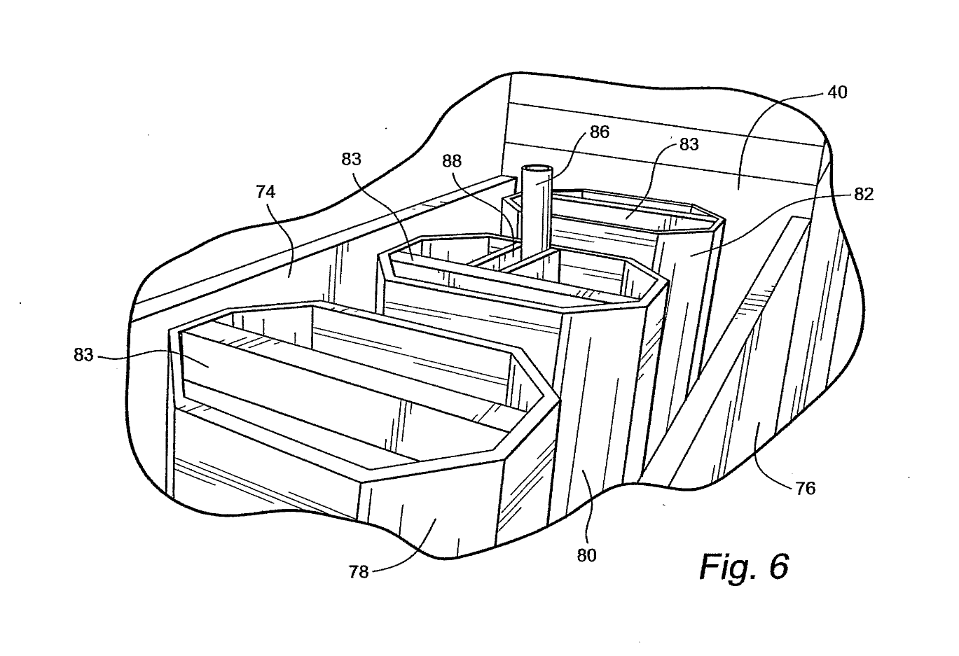

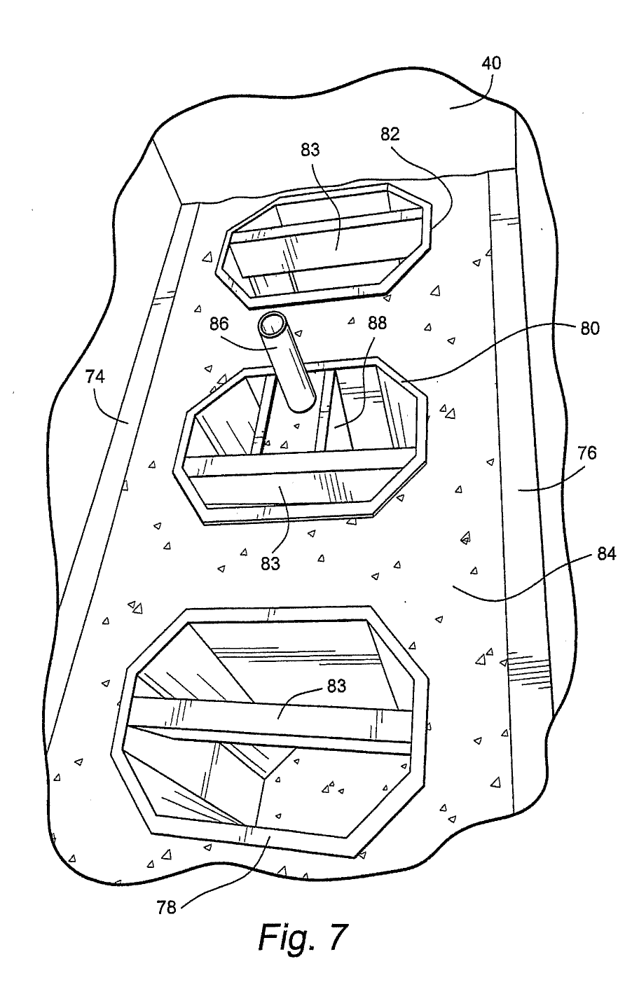

Thus, the first stage of the construction involves the placement of external wall forms 74 and 76, in combination with consumable “box” forms 78, 80 and 82 located within the confines of the outer forms to thereby define the discrete internal, vertically-oriented flue (or other) passages. It will be appreciated that within the various internal box forms, additional form work or bracing may be added as necessary to either provide support for the internal forms or to define additional sub-passages within the flues (see, for example, braces 83 in FIGS. 6 and 7. For the oven side walls, the forms must be set so that the poured wall will be flush with the existing brick work. For the internal flues, the forms must be set so that the poured wall will be about ⅛ inch to the inside of existing brick work. The castable refractory material 84 is pumped into the enclosed area, and around the internal flue forms, as shown in FIG. 7. It will be appreciated that refractory material may also be pumped within certain defined areas of the internal box forms, as shown for example in FIG. 7, where pipe 86 is surrounded by refractory material within a smaller boxed-in-portion 88 of the larger flue passage.

The refractory material may be a product sold under the name FosKast FS-P available from Fosbel, Inc., of Brook Park, Ohio, USA. This is a fused, silica-based, zero expansion, pumpable, castable designed for severe service applications requiring high mechanical strength and resistance to thermal shock, with a minimum service temperature of 2800° F. (1538° C.). The material is installed in the formwork preferably by pumping into the formwork from above the respective form sections, using an industrial concrete vibrator to ensure uniformity of material while pumping. Thereafter, a second stage form construction substantially identical to that described above (or modified as needed), is stacked on top of the first stage, and the pumping process repeated. Ceramic welds are installed at the tie in joints.

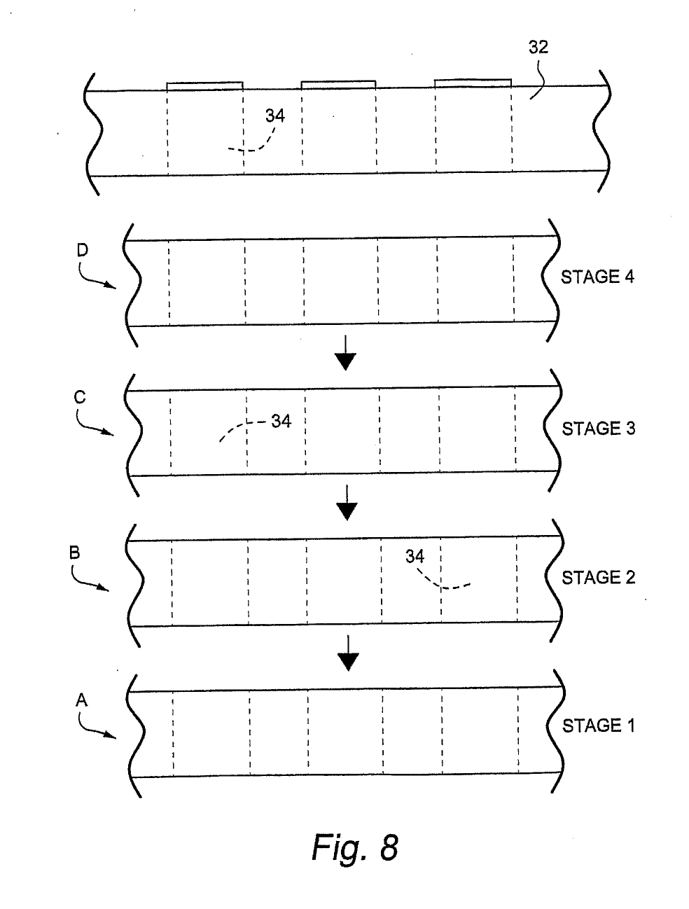

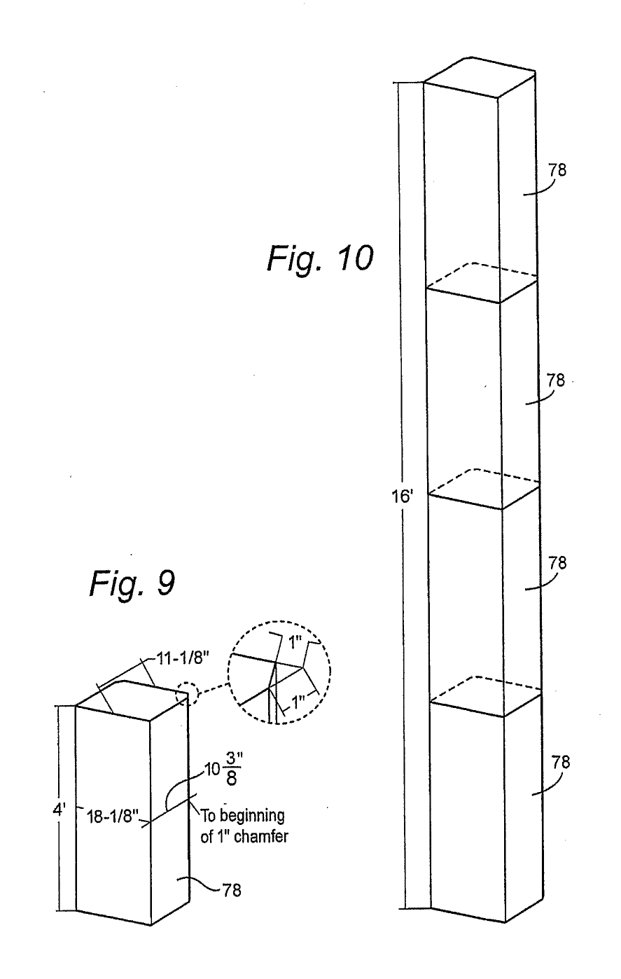

This process of stacking forms and pouring/curing the refractory material is repeated until the new wall reaches substantially the height of the roof 32. This procedure is shown schematically in FIG. 8 where forms A, B, C, and D are stacked in succession in respective stages 1-4. FIGS. 9 and 10 show how a similar stacking arrangement is used to form an internal flue or chimney passage, using multiple box forms 78, for example. The number of stages will depend on the height of the wall and the size of the individual form sections. At the roof level, there are two options for completing the wall.

In one embodiment, the formwork is brought as close as possible to the roof and then a second phase of pumping takes place to pump the roof section. In another embodiment, a portion of the roof corresponding to the repaired wall area is removed and the framework will then extend through the roof opening, with the adjacent roof sides forming a part of the formwork. In this case, the forms will be sized such that the final pour will be substantially flush with the outer surface of the roof.

The material is then allowed to cure, following the material manufacturer's recommendations. Subsequently, all remaining braces will be removed and the internal forms burned out thru a complex controlled heat up over 60 hours for dry out and curing.

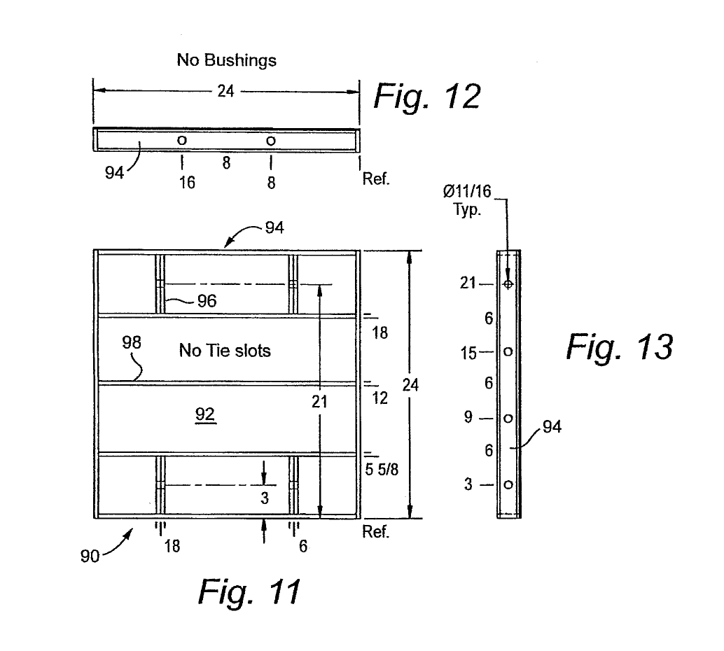

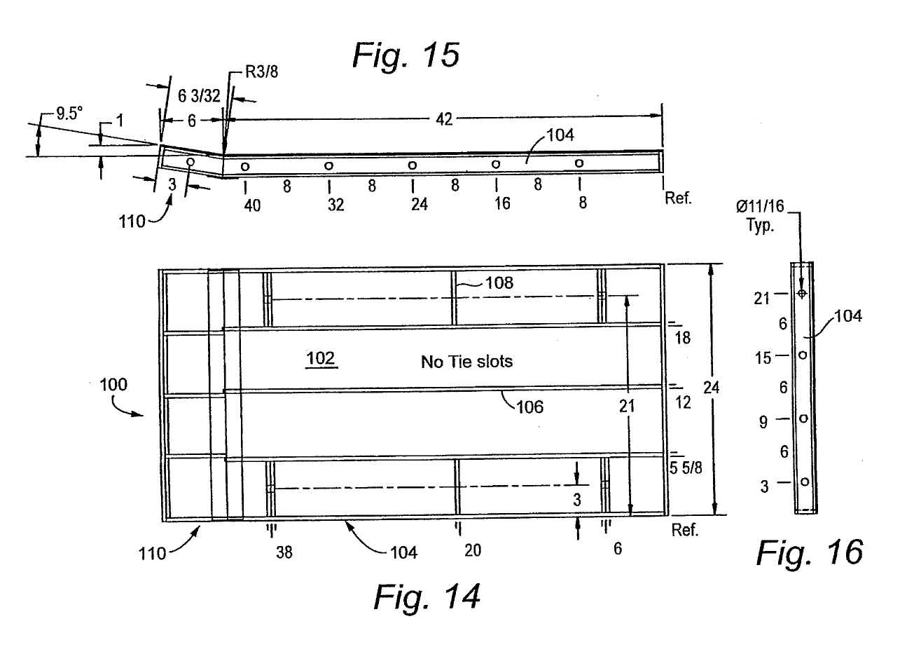

It will be appreciated that there may be several different sized and shaped forms that are required to cast around various oven components. FIGS. 11-16 are illustrative in this regard. FIGS. 11-13 show a square form 90 (twenty four inches on a side) composed of a solid side panel 92 surrounded by a solid frame 94, in combination with internal braces shown at 96, 98 for example. FIGS. 14-16 show a rectangular elongated outer form 100 (48″ by 24″), also composed of a single side panel 102 surrounded by a solid frame 104, and also utilizing interior braces 106, 108. One end of the form is angled or bent at 110, it being understood that this configuration is merely exemplary of any number of form shapes that may be required in any given field application. As no two installations are alike, each installation must be individually engineered to encompass all of different heating flue designs and interior brickwork designs and dimensional characteristics.

The repair/reconstruction process described herein has many advantages over the prior practice of replacing the damaged silica bricks on an individual basis. For example, typical long lead time brick delivery delays are eliminated; the reconstruction is far less complex labor intensive; shorter heat up cycle, the process easily accommodates expanded oven walls, and existing roofs can be preserved if desired. In addition, lost production days and hence lost production costs are reduced.

It is understood that this disclosure does not describe even in general terms all of the safety precautions/procedures that may be mandated or otherwise deemed appropriate for carrying out repairs in a coke oven or similar. Such precautions/procedures are well known to those skilled in this art, and therefore need not be described herein.

As already mentioned above, the process disclosed herein is equally applicable to the oven roof (or portions thereof) and to the corbel or floor area (or portions thereof).

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of repairing a refractory brick wall in a furnace comprising:
(a) identifying a refractory brick wall or portion thereof that requires repair/reconstruction;
(b) demolishing the refractory brick wall or wall portion thereof identified in step (a);
(c) installing'outer reusable forms in situ, defining a new wall or portion thereof;
(d) installing inner consumable forms defining one or more passageways within said new wall or portion thereof; and
(e) pouring castable material into one or more areas bounded by said outer forms;
(f) removing the outer reuseable forms, and
(g) curing said castable material installed thru a controlled 60 hour heat up cycle

2. The method of claim 1 wherein steps (c) through (f) are carried out to form a first section of said new wall or portion thereof of a height less than a finished height for said new wall or portion thereof; and wherein the method further comprises repeating steps (c) through (e) to form one or more additional sections, stacked one on the other, until said finished height is achieved.

3. The method of claim 1 wherein said refractory brick wall comprises at least a portion of a heating wall between adjacent heating chambers in a coke oven.

4. The method of claim 3 wherein said inner forms define at least one vertically-oriented flue passage.

5. The method of claim 1 wherein said inner forms are constructed of wood.

6. The method of claim 1 wherein said inner forms are constructed of cardboard or fiberboard.

7. The method of claim 1 wherein said castable material is a fused, silica-based material.

8. The method of claim 1 wherein said outer forms are comprised of metal material.

9. The method of claim 1 wherein said outer forms are comprised of a wood-metal laminate.

10. The method of claim 9 wherein the wood-metal laminate comprises plywood on an inner side and aluminum on an outer side thereof.

11. A method of replacing all or a portion of a ceramic brick heating wall in a coke oven, the heating wall located between a pair of adjacent ovens and containing at least one flue passage, the method comprising:
(a) demolishing said wall or portion thereof;
(b) installing outer forms defining a new wall or portion thereof in situ, between said adjacent ovens, and inner consumable forms defining at least one new flue passage within said new wall or portion thereof;
(c) pouring a refractory castable material within said outer forms and around said inner forms and allowing said material to cure;
(d) removing said outer forms; and
(e) burning out said inner consumable forms.

12. The method of claim 11 wherein said inner consumable forms are constructed of fiberboard or cardboard.

13. The method of claim 11 wherein said inner consumable forms are constructed of plywood.

14. The method of claim 11 wherein steps (b) and (c) are carried out to form a first section of said new wall or portion thereof of a height less than a finished height for said new wall or portion thereof; and wherein the method further comprises repeating steps (b) and (c) to form one or more additional sections, stacked one on the other, until said finished height is achieved.

15. The method of claim 14 including applying ceramic welds at the tie in joints between adjacent sections.

16. The method of claim 14 including removing a portion of a roof over the oven and using adjacent sides of the roof as outer forms, and pouring the refractory castable material to a height substantially flush with the roof.
